(19) United States
(12) Patent Application Publication
(10) Pub. No.: US 2011/0102553 A1
(43) Pub. Date: May 5, 2011

(54) ENHANCED REAL-TIME FACE MODELS FROM STEREO IMAGING

(75) Inventors: Peter Corcoran, Claregalway (IE); Petronel Bigioi, Galway (IE); Mircea C. Ionita, Galway (IE)

(73) Assignee: TESSERA TECHNOLOGIES IRELAND LIMITED, Galway (IE)

(21) Appl. No.: 12/824,204

(22) Filed: Jun. 27, 2010

Related U.S. Application Data
(63) Continuation-in-part of application No. 12/038,147, filed on Feb. 27, 2008.
(60) Provisional application No. 61/221,425, filed on Jun. 29, 2009.
(60) Provisional application No. 60/892,238, filed on Feb. 28, 2007.

(51) Int. Cl. H04N 13/02; G06K 9/00

(52) U.S. Cl. 348/50; 382/154; 348/E13.074

(57) ABSTRACT

A stereoscopic image of a face is generated. A depth map is created based on the stereoscopic image. A 3D face model of the face region is generated from the stereoscopic image and the depth map. The 3D face model is applied to process an image.

### PRIORITY

This application claims priority to U.S. provisional patent application Ser. No. 61/221,425, filed Jun. 29, 2009. This application is also a continuation in part (CIP) of U.S. patent application no. 12/038,147, filed Feb. 27, 2008, which claims priority to U.S. provisional 60/892,238, filed Feb. 28, 2007. These priority applications are incorporated by reference.

### BACKGROUND

Face detection and tracking technology has become commonplace in digital cameras in the last year or so. All of the practical embodiments of this technology are based on Haar classifiers and follow some variant of the classifier cascade originally proposed by Viola and Jones (see P. A. Viola, M. J. Jones, “Robust real-time face detection”, International Journal of Computer Vision, vol. 57, no. 2, pp. 137-154, 2004, incorporated by reference). These Haar classifiers are rectangular and by computing a grayscale integral image mapping of the original image it is possible to implement a highly efficient multi-classifier cascade. These techniques are also well suited for hardware implementations (see A. Bigdeli, C. Sim, M. Biglari-Abhari and B. C. Lovell, Face Detection on Embedded Systems, Proceedings of the 3rd international conference on Embedded Software and Systems, Springer Lecture Notes In Computer Science; Vol. 4523, p 295-308, May 2007, incorporated by reference).

Now, despite the rapid adoption of such in-camera face tracking, the tangible benefits are primarily in improved enhancement of the global image. An analysis of the face regions in an image enables improved exposure and focal settings to be achieved. However current techniques can only determine the approximate face region and do not permit any detailed matching to facial orientation or pose. Neither do they permit matching to local features within the face region. Matching to such detailed characteristics of a face region would enable more sophisticated use of face data and the creation of real-time facial animations for use in, for example, gaming avatars. Another field of application for next-generation gaming technology would be the use of real-time face models for novel user interfaces employing face data to initiate game events, or to modify difficult levels based on the facial expression of a gamer.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A and 1B illustrate an example of annotations used for the Yale B Database.

FIG. 2A illustrates variation between individuals.

FIG. 2B illustrates estimated albedo of the individuals of FIG. 2A.

FIG. 2C illustrates albedo eigen-textures with 95% energy preservation.

FIG. 3A illustrates a reference sample subset of images with various directional lighting effects.

FIG. 3B illustrate face samples from FIG. 3A with the contribution of directional lighting removed by filtering (see equation 5).

FIG. 4 illustrates images of FIG. 3B subtracted from images of FIG. 3A to yield a set of difference (residual) images.

FIG. 5 illustrates process steps to build a color extension of the combined DLS+ULS model for face recognition.

FIG. 6 illustrates a general architecture for real-time stereo video capture.

FIG. 7 illustrates an internal architecture for real-time stereo video capture.

FIG. 8 illustrates a stereo face image pair example.

FIG. 9 illustrates the Parallax Effect.

FIG. 10 illustrates a depth map result for the stereo image pair of FIG. 8.

FIG. 11 illustrates a fitted AAM face model on the stereo pair of FIG. 8.

FIG. 12 illustrates corresponding triangulated meshes for a fitted model.

FIG. 13 illustrates generating a 3D shape from 2D stereo data with triangulation-based warping.

FIG. 14A illustrates progressive blurring.

FIG. 14B illustrates selective blurring.

FIG. 15A illustrates Frontal Face, with simple Directional Lighting.

FIG. 15B illustrates Directional Lighting—Note Shadows from Eyelashes and Nose demonstrating sophisticated post-acquisition effects possible with 3D model.

FIG. 15C illustrates Directional Lighting—Note cheek regions is strongly shaded although it is to the foreground, demonstrating the selective application of the directional lighting effect to the cheek and eye regions. Here too we see the eyelash shadows.

FIG. 16 illustrates an estimated 3D profile from 2D stereo data using Thin Plate Spline—based warping.

### DETAILED DESCRIPTIONS OF THE EMBODIMENTS

Techniques for improved 2D active appearance face models are described below. When these are applied to stereoscopic image pairs we show that sufficient information on image depth is obtained to generate an approximate 3D face model. Two techniques are investigated, the first based on 2D+3D AAMs and the second using methods based on thin plate splines. The resulting 3D models can offer a practical real-time face model which is suitable for a range of applications in computer gaming. Due to the compact nature of AAMs these are also very suitable for use in embedded devices such as gaming peripherals.

A particular class of 2D affine models are involved in certain embodiments, known as active appearance models (AAM), which are relatively fast and are sufficiently optimal to be suitable for in-camera implementations. To improve the speed and robustness of these models, several enhancements are described. Improvements are provided for example to (i) deal with directional lighting effects and (ii) make use of the full color range to improve accuracy and convergence of model to a detected face region.

Additionally, the use of stereo imaging provides improved model registration by using two real-time video images with slight variations in spatial perspective. As AAM models may comprise 2D affine models, the use of a real-time stereo video stream opens interesting possibilities to advantageously create full 3D face model from the 2D real-time models.

An overview of these models is provided below along with example steps in constructing certain AAM models. Embodiments are also provided with regard to handling directional lighting. The use of the full color range is provided in example models and it is demonstrated below that color information can be used advantageously to improve both the accuracy and speed of convergence of the model. A method is provided for performing face recognition, and comparative analysis shows that results from improved models according to certain embodiments are significantly better than those obtained from a conventional AAM or from a conventional eigenfaces method for performing face recognition. A differential stereo model is also provided which can be used to further enhance model registration and which offers the means to extend a 2D real-time model to a pseudo 3D model. An approach is also provided for generating realistic 3D avatars based on a computationally reduced thin plate spline warping technique. The method incorporates modeling enhancements also described herein. Embodiments that involve the use of AAM models across a range of gaming applications is also provided.

### AAM Overview

This section explains the fundamentals of creating a statistical model of appearance and of fitting the model to image regions.

### Statistical Models of Appearance

AAM was proposed by T. F. Cootes (see, e.g., T. F. Cootes, G. J. Edwards, and C. J. Taylor, “Active appearance models”, Lecture Notes in Computer Science, vol. 1407, pp. 484-, 1998, incorporated by reference), as a deformable model, capable of interpreting and synthesizing new images of the object of interest. Statistical Models of Appearance represent both the shape and texture variations and the correlations between them for a particular class of objects. Example members of the class of objects to be modeled are annotated by a number of landmark points. The shape is defined by the number of landmarks chosen to best depict the contour of the object of interest, in our case a person's face.

### Model Fitting to an Image Region

After a statistical model of appearance is created, an AAM algorithm can be employed to fit the model to a new, unseen, image region. The statistical model is linear in both shape and texture. However, fitting the model to a new image region is a non-linear optimization process. The fitting algorithm works by minimizing the error between a query image and the equivalent model-synthesized image.

In this paper we use an optimization scheme which is robust to directional variations in illumination. This relies on the fact that lighting information is decoupled from facial identity information. This can be seen as an adaptation of the method(s) proposed at A. U. Batur and M. H. Hayes, “Adaptive active appearance models,” IEEE Transactions on Image Processing, vol. 14, no. 11, pp. 1707-1721, 2005, incorporated by reference. These authors use an adaptive gradient where the gradient matrix is linearly adapted according to the texture composition of the target image, generating an improved estimate of the actual gradient. In our model the separation of texture into lighting dependent and lighting independent subspaces enables a faster adaptation of the gradient.

### Initialization of the Model within an Image

Prior to implementing that AAM fitting procedure it is necessary to initialize the model within an image. To detect faces we employ a modified Viola-Jones face detector (see J. J. Gerbrands, “On the relationships between SVD, KLT and PCA.” Pattern Recognition, vol. 14, no. 1-6, pp. 375-381, 1981, incorporated by reference) which can accurately estimate the position of the eye regions within a face region. Using the separation of the eye regions also provides an initial size estimate for the model fitting. The speed and accuracy of this detector enables us to apply the AAM model to large unconstrained image sets without a need to pre-filter or crop face regions from the input image set.

### Model Enhancements

### Illumination and Multi-Channel Colour Registration

### Building an Initial Identity Model

The reference shape used to generate the texture vectors should be the same one for all models, i.e. either identity or directional lighting models. Our goal is to determine specialized subspaces, such as the identity subspace or the directional lighting subspace.

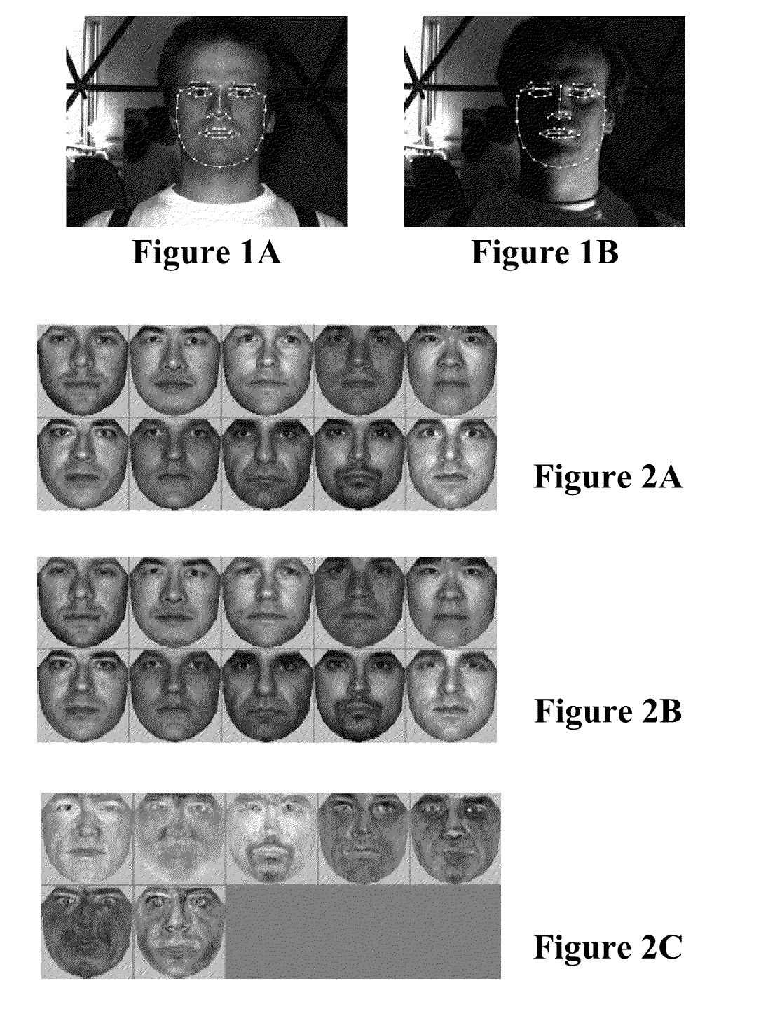

We first need to model only the identity variation between individuals. For training this identity-specific model we only use images without directional lighting variation. Ideally these face images should be obtained in diffuse lighting conditions. Textures are extracted by projecting the pixel intensities across the facial region, as defined by manual annotation, into the reference shape—chosen as the mean shape of the training data. FIG. 1 illustrates examples of annotations used for the Yale B Database.

The number of landmark points used should be kept fixed over the training data set. In addition to this, each landmark point must have the same face geometry correspondence for all images. The landmarks should predominantly target fiducial points, which permit a good description of facial geometry, allowing as well the extraction of geometrical differences between different individuals. The facial textures corresponding to images of individuals in the Yale database with frontal illumination are represented in FIGS. 2A, 2B and 2C. FIG. 2A illustrates variation between individuals. FIG. 2B illustrates estimated albedo of the individuals. FIG. 2C illustrates albedo eigen-textures with 95% energy preservation. The identity model can now be generated from the albedo images based on the standard PCA technique.

### Building a Model for Directional Lighting Variations

Consider now all facial texture which exhibit directional lighting variations from all four (4) subsets. These textures are firstly projected onto the previously built subspace of individual variation, ULS. These texture vectors contain some directional lighting information, with g.

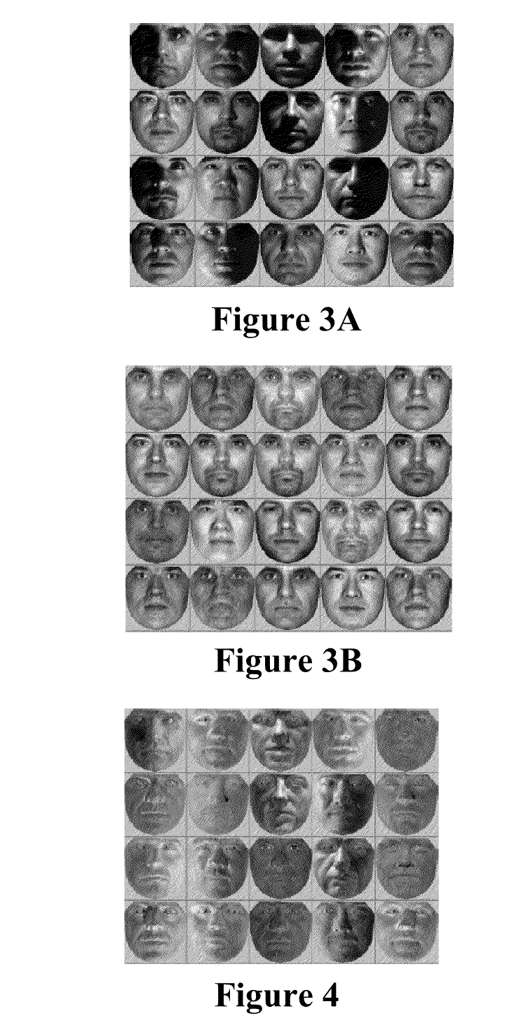

In equation 1 below, the factor g contains both identity and directional lighting information. The same reference shape may be used to obtain the new texture vectors g, which ensures that the previous and new texture vectors have all equal lengths. In FIG. 3A, a random selection of faces is shown as a reference sample subset of images with various directional lighting effects. The projection of the texture vectors g onto ULS gives the sets of optimal texture parameter vectors as in:

b_{ident}^{(opt)}=Φ_{ident}^{T}(g− t̅) (1)

The back-projection stage returns the texture vector, optimally synthesized by the identity model. The projection/back-projection process filters out all the variations which could not be explained by the identity model. Thus, for this case, directional lighting variations are filtered out by this process,

g_{filt}= t̅+Φ_{ident}b_{ident}^{(opt)} (2)

Continuing with the procedure for the examples in FIG. 3A, their filtered versions are illustrated in the example of FIG. 3B, which illustrates face samples from FIG. 3A with the contribution of directional lighting removed by filtering (per equation 5, below).

The residual texture is further obtained as the difference between the original texture and the synthesized texture which retained only the identity information. This residual texture normally retains the information other than identity.

tᵣₑₛ=g−g_{filt}=g− t̅−Φ_{ident}b_{ident}^{(opt)} (3)

The residual images give the directional lighting information, as illustrated at FIG. 4 which includes the images of FIG. 3B subtracted from the images of FIG. 3A to yield a set of difference (residual) images. These residuals are then modeled using PCA in order to generate a directional lighting subspace.

### Creating a Merged Face Model

As described above, three separate components of the face model have been generated. These are: (i) the shape model of the face, (ii) texture model encoding identity information, and (iii) the texture model for directional lighting. The resulting texture subspaces are also orthogonal due to the approach described above. The fusion between the two texture models can be realized by a weighted concatenation of parameters:

$$c = [ \begin{matrix}{W}_{S} {b}_{S} \\ {b}_{ident} \\ {W}_{light} {b}_{light}\end{matrix} ] \qquad ( 4 )$$

where W_{lighting} and Ws are two vectors of weights used to compensate for the differences in units between the two sets of texture parameters, and for the differences in units between shape and texture parameters, respectively.

### Fitting the Lighting Enhanced Model

The conventional AAM algorithm uses a gradient estimate built from training images and thus cannot be successfully applied to images where there are significant variations in illumination conditions. The solution proposed by Batur et al. is based on using an adaptive gradient AAM (see, e.g., F. Kahraman, M. Gokmen, S. Darkner, and R. Larsen, “An active illumination and appearance (AIA) model for face alignment,” Computer Vision and Pattern Recognition, 2007. CVPR '07. IEEE Conference on, pp. 1-7, June 2007. The gradient matrix is linearly adapted according to texture composition of the target image. We further modify the approach of Batur (cited above) to handle our combined ULS and DLS texture subspace (see, e.g., M. Ionita, “Advances in the design of statistical face modeling techniques for face recognition”, PhD Thesis, NUI Galway, 2009, and M. Ionita and P. Corcoran, “A Lighting Enhanced Facial Model: Training and Fast Optimization Scheme”, submitted to Pattern Recognition, May 2009, which are incorporated by reference.

### Colour Space Enhancements

When a typical multi-channel image is represented in a conventional color space such as RGB, there are correlations between its channels. For natural images, the cross-correlation coefficient between B and R channels is ˜0.78, between R and G channels is ˜0.98, and for G and B channels is ˜0.94 (see M. Tkalcic and J. F. Tasic, “Colour spaces—perceptual, historical and applicational background,” in IEEE, EUROCON, 2003, incorporated by reference). This inter-channel correlation explains why previous authors (G. J. Edwards, T. F. Cootes, and C. J. Taylor, “Advances in active appearance models,” in International Conference on Computer Vision (ICCV'99), 1999, pp. 137-142, incorporated by reference) obtained poor results using RGB AAM models.

Ohta's space (see Y. Ohta, T. Kanade, and T. Sakai, “Color Information for Region Segmentation”, Ó Comput. Graphics Image Process., vol. 13, pp. 222-240, 1980, incorporated by reference) realizes a statistically optimal minimization of the inter-channel correlations, i.e. decorrelation of the color components, for natural images. The conversion from RGB to I1I2I3 is given by the simple linear transformations in (5a-c).

$$\begin{matrix}{I}_{1} = \frac{R + G + B}{3} & ( 5 a ) \\ {I}_{2} = \frac{R - B}{2} & ( 5 b ) \\ {I}_{3} = \frac{2 G - R - B}{4} & ( 5 c )\end{matrix}$$

I1 represents the achromatic (intensity) component, while I2 and I3 are the chromatic components. By using Ohta's space the AAM search algorithm becomes more robust to variations in lighting levels and color distributions. A summary of comparative results across different color spaces is provided in Tables I and II (see also M. C. Ionita, P. Corcoran, and V. Buzuloiu, “On color texture normalization for active appearance models,” IEEE Transactions on Image Processing, vol. 18, issue 6, pp. 1372-1378, June 2009 and M. Ionita, “Advances in the design of statistical face modeling techniques for face recognition”, PhD Thesis, NUI Galway, 2009, which are incorporated by reference).

TABLE I
TEXTURE NORMALISATION RESULTS
ON (PIE) SUBSET 2 (Unseen)

| | Success | Pt-Crv | Pt-Pt | PCTE |
|---|---|---|---|---|
| Model | [%] | (Mean/Std) | (Mean/Std) | (Mean/Std) |
| Grey scale | 88.46 | 3.93/2.00 | 6.91/5.45 | — |
| RGB ON | 80.77 | 3.75/1.77 | 7.09/4.99 | 7.20/2.25 |
| CIELAB GN | 100 | 2.70/0.93 | 4.36/1.63 | 5.91/1.19 |
| I1I2I3 SChN | 100 | 2.60/0.93 | 4.20/1.45 | 5.87/1.20 |
| RGB SChN | 73.08 | 4.50/2.77 | 8.73/7.20 | 7.25/2.67 |
| CIELAB SChN | 88.46 | 3.51/2.91 | 6.70/8.29 | 6.28/2.09 |
| I1I2I3 GN | 92.31 | 3.23/1.21 | 5.55/2.72 | 6.58/1.62 |

TABLE II
CONVERGENCE RESULTS ON UNSEEN DATABASES

| | Success | Pt-Crv | | | PTE | | |
|---|---|---|---|---|---|---|---|
| Model | Rate [%] | (Mean/Std/Median) | | | (Mean/Std/Median) | | |
| db1-Grayscale* | 92.17 | 5.10 | 1.66 | 4.90 | 4.28 | 1.03 | 4.21 |
| db1-RGB-name | 99.13 | 4.94 | 1.37 | 4.82 | 10.09 | 1.58 | 9.93 |
| db1-RGB-G | 98.26 | 4.98 | 1.44 | 4.65 | 7.49 | 1.98 | 7.02 |
| db1-RGB-Ch | 87.83 | 5.32 | 1.65 | 5.08 | 6.33 | 1.40 | 5.95 |
| db1-I1I2I3-Ch | 99.13 | 3.60 | 1.32 | 3.32 | 5.10 | 1.01 | 4.85 |
| db1-I1I2-Ch | 99.13 | 4.25 | 1.65 | 3.79 | 8.26 | 4.11 | 6.10 |
| db2-Grayscale* | 75.73 | 4.17 | 1.44 | 3.67 | 5.12 | 4.24 | 4.03 |
| db2-RGB-name | 84.47 | 4.02 | 1.40 | 3.69 | 12.43 | 3.43 | 12.41 |
| db2-RGB-G | 94.17 | 3.74 | 1.45 | 3.23 | 9.04 | 1.83 | 8.97 |
| db2-RGB-Ch | 62.14 | 4.01 | 1.60 | 3.46 | 7.70 | 4.26 | 6.06 |
| db2-I1I2I3-Ch | 88.35 | 3.31 | 1.26 | 2.98 | 6.16 | 2.28 | 5.73 |
| db2-I1I2-Ch | 87.38 | 3.60 | 1.55 | 3.04 | 10.00 | 3.41 | 8.94 |
| db3-Grayscale* | 63.89 | 4.85 | 2.12 | 4.26 | 4.90 | 3.44 | 3.98 |
| db3-RGB-name | 75.22 | 4.44 | 1.79 | 3.99 | 14.23 | 4.79 | 13.34 |
| db3-RGB-G | 65.28 | 4.55 | 2.03 | 4.01 | 9.68 | 2.81 | 9.27 |
| db3-RGB-Ch | 59.72 | 5.02 | 2.04 | 4.26 | 7.16 | 4.91 | 5.74 |
| db3-I1I2I3-Ch | 86.81 | 3.53 | 1.49 | 3.15 | 6.04 | 2.56 | 5.20 |
| db3-I1I2-Ch | 86.81 | 3.90 | 1.66 | 3.41 | 6.60 | 1.94 | 6.30 |

### Uses of Statistical Models and AAM

An advantageous AAM model may be used in face recognition. However there are a multitude of alternative applications for such models. These models have been widely used for face tracking (see, e.g., P. Corcoran, M. C. Ionita, I. Barcivarov, “Next generation face tracking technology using AAM techniques,” Signals, Circuits and Systems, ISSCS 2007, International Symposium on, Volume 1, p 1-4, 13-14 Jul. 2007, incorporated by reference), and for measuring facial pose and orientation.

In other research we have demonstrated the use of AAM models for detecting phenomena such as eye-blink, analysis and characterization of mouth regions, and facial expressions (see I. Bacivarov, M. Ionita, P. Corcoran, “Statistical Models of Appearance for Eye Tracking and Eye-Blink Detection and Measurement”. IEEE Transactions on Consumer Electronics, August 2008; I. Bacivarov, M. C. Ionita, and P. Corcoran, A Combined Approach to Feature Extraction for Mouth Characterization and Tracking, in Signals and Systems Conference, 208. (ISSC 2008). IET Irish, Volume 1, p 156-161, Galway, Ireland 18-19 Jun. 2008; and J. Shi, A. Samal, and D. Marx, “How effective are landmarks and their geometry for face recognition?” Comput. Vis. Image Underst., vol. 102, no. 2, pp. 117-133, 2006, respectively, which are incorporated by reference). In such context these models are more sophisticated than other pattern recognition methods which can only determine if, for example, an eye is in an open or closed state. Our models can determine other metrics such as the degree to which an eye region is open or closed or the gaze direction of the eye. This opens the potential for sophisticated game avatars or novel gaming UI methods.

### Building a Combined Model

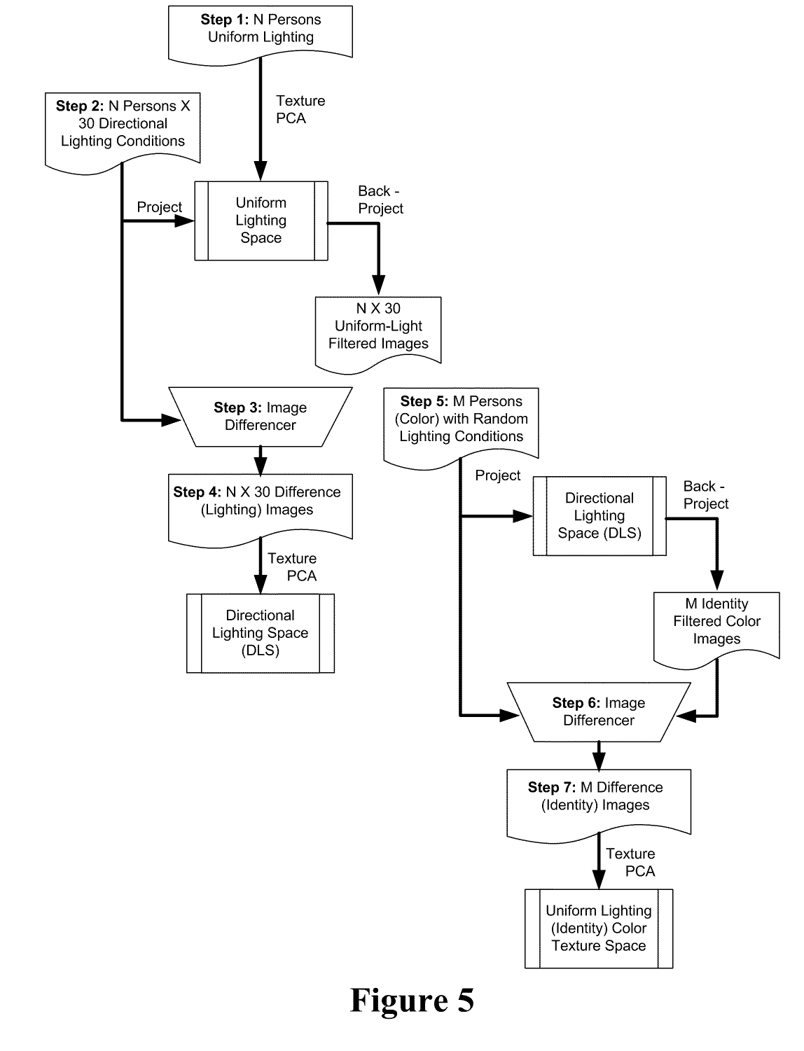

A notable applicability of the directional lighting sub-model, generated from a grayscale training database, is that it can be efficiently incorporated into a color face model. This process is illustrated in FIG. 5 which shows a process steps to build a color extension of the combined DLS+ULS model for face recognition.

The left-hand process diagram of FIG. 5 illustrates the partitioning of the model texture space into orthogonal ULS and DLS subspaces. Step 1 involves N persons and uniform lighting. Step 2 involves N persons and 30 directional lighting conditions. Using texture PCA, step 1 moves to uniform lighting space (ULS), and using projection, step 2 moves to the ULS. Using back projection, N×30 uniform light filtered images are the result. Step 3 involves an image difference fed by the step 2 images and the resultant N×3-uniform light filtered images. Step 4 involves N×30 difference lighting images. Using texture PCA, a directional lighting space (DLS) is achieved.

The right-hand side process diagram of FIG. 5 shows how the DLS subspace can be used to train a color ULS, implemented in the other color space. Step 5 involves M persons in color with random lighting conditions. These are fed to the directional lighting subspace (DLS). Using back projection, M identity filtered color images are achieved and fed at step 6 to an image difference along with the m persons in color with random lighting conditions. Step 7 then involves M difference (identity) images. Using texture PCA, a uniform lighting (identity) color texture space (ULCTS) is achieved.

The example processes illustrated at FIG. 5 yield a full color ULS which retains the orthogonality with the DLS and when combined with it yields an enhanced AAM model incorporating shape+DLS+color ULS subspaces. The color ULS has the same improved fitting characteristics as the color model (see, M. C. Ionita, P. Corcoran, and V. Buzuloiu, “On color texture normalization for active appearance models,” IEEE Transactions on Image Processing, vol. 18, issue 6, pp. 1372-1378, June 2009, incorporated by reference). This combined model exhibits both improved registration and robustness to directional lighting.

### Model Application to Face Recognition

### Benchmarking for AAM-Based Face Recognition

The recognition tests which follow have been performed by considering the large gallery test performance (see P. J. Phillips, P. Rauss, and S. Der, “FERET recognition algorithm development and test report,” U.S. Army Research Laboratory, Tech. Rep., 1996, incorporated by reference). As a benchmark with other methods we decided to compare relative performance with respect to the well-known eigenfaces method (see M. A. Turk and A. P. Pentland, “Face recognition using eigenfaces,” in Proc. IEEE Conference on Computer Vision and Pattern Recognition (CVPR'91), 586-591, 1991, incorporated by reference). Detailed results of these tests are reported in M. Ionita, “Advances in the design of statistical face modeling techniques for face recognition”, PhD Thesis, NUI Galway, 2009, incorporated by reference. There is a reported modest improvement of 5%-8% to be achieved in using a color AAM method (RGB) over a grayscale AAM. The performance of the color AAM is approximately equal to that of both grayscale and color eigenfaces methods.

### Tests on the Improved AAM Model

The color AAM techniques based on RGB color space generally cannot compete with the conventional eigenface method of face recognition. Conversely, the I1I2I3 based models perform at least as well as the eigenface method, even when the model has been trained on a different database. When trained on the same database we conclude that the I1I2I3 SChN model outperforms the eigenface method by at least 10% when the first 50 components are used. If we restrict our model to the first 5 or 10 components then the differential is about 20% in favor of the improved AAM model.

### Model Enhancements

### Differential AAM from Real-Time Stereo Channels

### Hardware Architecture of Stereo Imaging System

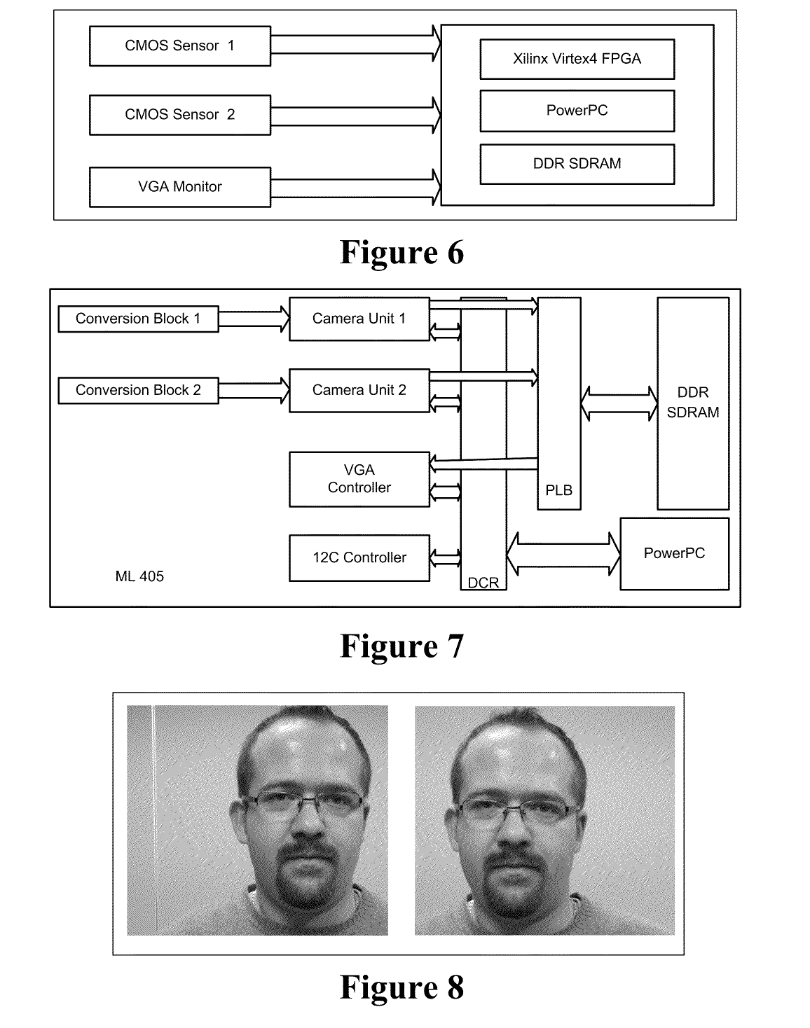

An example of a general architecture of a stereo imaging system is illustrated at FIG. 6, which shows two CMOS sensors and a VGA monitor connected to a power PC with Xilinx Virtex4 FPGA and DDR SDRAM. The two CMOS sensors are connected to an FPGA which incorporates a PowerPC core and associated SDRAM. Additional system components can be added to implement a dual stereo image processing pipeline (see, e.g., I. Andorko and P. Corcoran, “FPGA Based Stereo Imaging System with Applications in Computer Gaming”, at International IEEE Consumer Electronics Society's Games Innovations Conference 2009 (ICE-GIC 09), London, UK, incorporated by reference).

The development board is a Xilinx ML405 development board, with a Virtex 4 FPGA, a 64 MB DDR SDRAM memory, and a PowerPC RISC processor. The clock frequency of the system is 100 MHz. An example internal architecture of the system in accordance with certain embodiments is illustrated at FIG. 7, which shows two conversion blocks respectively coupled to camera units 1 and 2. The camera units 1 and 2 feed a PLB that feeds a VGA controller. A DCR is connected to the camera units 1 and 2, the VGA controller, an I2C controller and a Power PC. The PLB is also coupled with DDR SDRAM. The sensor used in this embodiment includes a ⅓ inch SXGA CMOS sensor made by Micron. It has an active zone of 1280×1024 pixels. It is programmable through the I2C interface. It works at 13.9 fps and the clock frequency is 25 MHz. This sensor was selected because of its small size, low cost and the specifications of these sensors are satisfactory for this project. This system enables real-time stereo video capture with a fixed distance between the two imaging sensors. FIG. 8 illustrates a stereo face image pair example.

### Determination of a Depth Map

When using two sensors for stereo imaging, the problem of parallax effect appears. Parallax is an apparent displacement or difference of orientation of an object viewed along two different lines of sight, and is measured by the angle or semi-angle of inclination between those two lines.

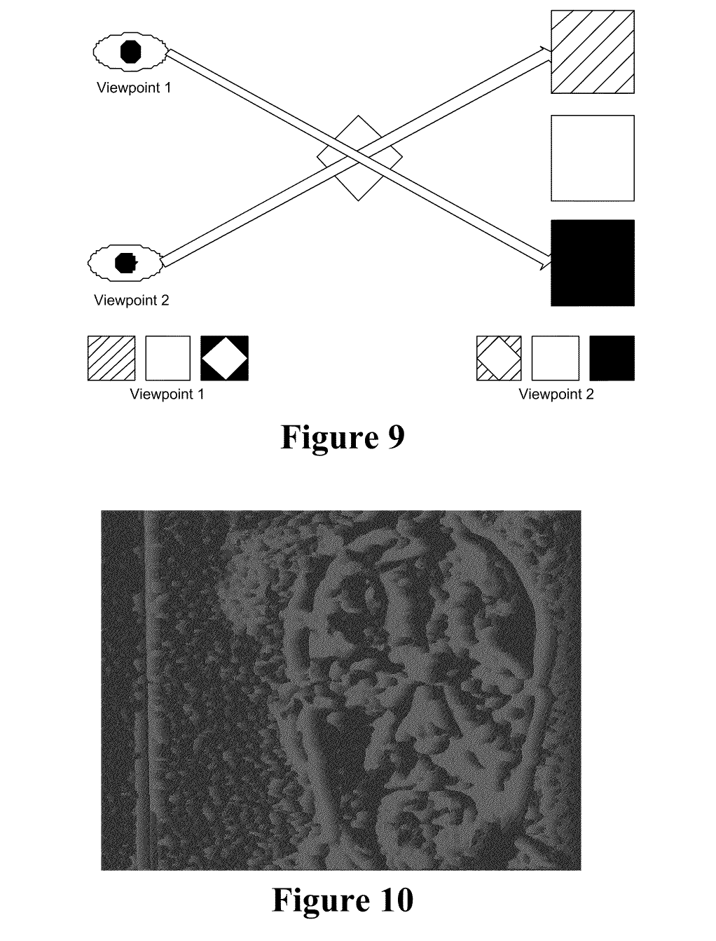

The advantage of the parallax effect is that with the help of this, depth maps can be computed. The computation in certain embodiments involves use of pairs of rectified images (see, K. Muhlmann, D. Maier, J. Hesser, R. Manner, “Calculating Dense Disparity Maps from Color Stereo Images, an Efficient Implementation”, International Journal of Computer Vision, vol. 47, numbers 1-3, pp. 79-88, April 2002, incorporated by reference). This means that corresponding epipolar lines are horizontal and on the same height. The search of corresponding pictures takes place in horizontal direction only in certain embodiments. For every pixel in the left image, the goal is to find the corresponding pixel in the right image, or vice-versa. FIG. 9 illustrates the parallax effect.

It is difficult or at least computationally expensive to find corresponding single pixels, and so windows of different sizes (3×3; 5×5; 7×7) may be used. The size of window is computed based on the value of the local variation of each pixel (see C. Georgoulas, L. Kotoulas, G. Ch. Sirakoulis, I. Andreadis, A. Gasteratos, “Real-Time Disparity Map Computation Module”, Microprocessors and Microsystems 32, pp. 159-170, 2008, incorporated by reference). A formula that may be used for the computation of the local variation per Georgoulas et al. is shown below n equation 6:

$$LV ( p ) = {\sum }_{i = 1}^{N} {\sum }_{j = 1}^{N} \vert I ( i , j ) - μ \vert \qquad ( 6 )$$

where μ is the average grayscale value of image window, and N is the selected square window size.

The first local variation calculation may be made over a 3×3 window. After this, the points with a value under a certain threshold are marked for further processing. The same operation is done for 5×5 and 7×7 windows as well. The size of each of the windows is stored for use in the depth map computation. The operation to compute the depth map is the Sum of Absolute Differences for RGB images (SAD). The value of SAD is computed for up to a maximum value of d on the x line. After all the SAD values have been computed, the minimum value of SAD(x,y,d) is chosen, and the value of d from this minimum will be the value of the pixel in the depth map. At searching the minimum, there are some problems that we should be aware of. If the minimum is not unique, or its position is dₘᵢₙ or dₘₐₓ, the value is discarded. Instead of just seeking the minimum, it is helpful to track the three smallest SAD values as well. The minimum defines a threshold above which the third smallest value must lie. Otherwise, the value is discarded. FIG. 10 illustrates a depth map result for the stereo image pair illustrated in FIG. 8.

One of the conditions for a depth map computation technique to work properly is that the stereo image pairs should contain strong contrast between the colors within the image and there should not be large areas of nearly uniform color. Other researchers who attempted the implementation of this algorithm used computer generated stereo image pairs which contained multiple colors (see Georgoulas et al. and L. Di Stefano, M. Marchionni, and S. Mattoccia, “A Fast Area-Based Stereo Matching Algorithm”, Image and Vision Computing, pp. 983-1005, 2004, which are incorporated by reference). In some cases, the results after applying the algorithm for faces can be sub-optimal, because the color of facial skin is uniform across most of the face region and the algorithm may not be able to find exactly similar pixels in the stereo image pair.

### AAM Enhanced Shape Model

A face model may involve two, orthogonal texture spaces. The development of a dual orthogonal shape subspace is described below which may be derived from the difference and averaged values of the landmark points derived from the right-hand and left hand stereo face images. This separation provides us with an improved 2D registration estimate from the averaged landmark point locations and an orthogonal subspace derived from the different values.

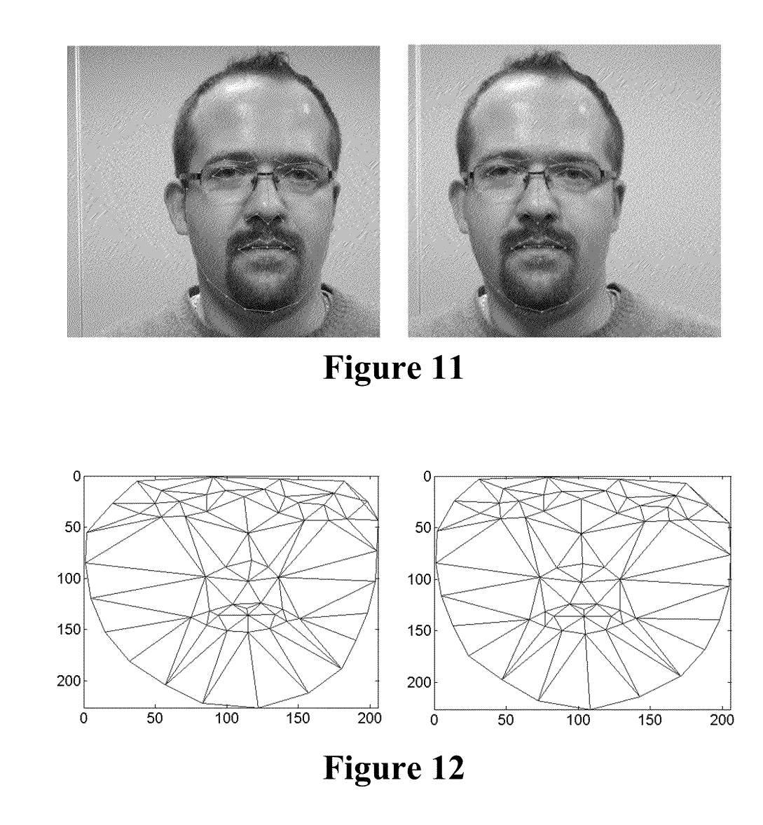

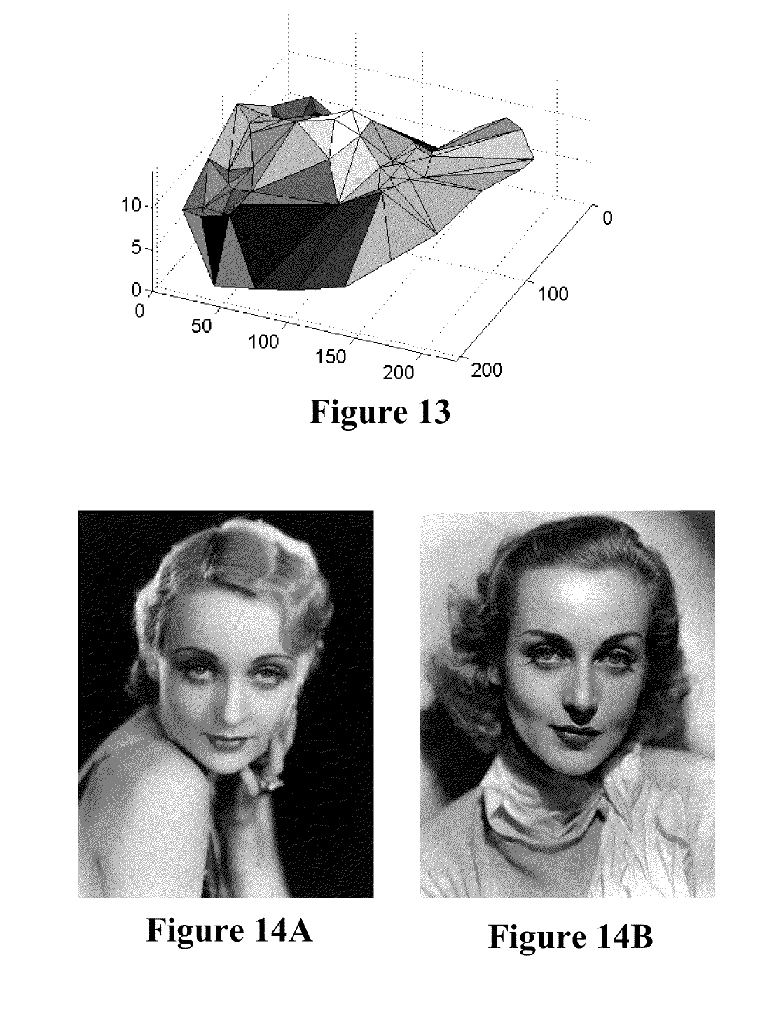

This second subspace enables an improved determination of the SAD values and the estimation of an enhanced 3D surface view over the face region. FIG. 11 illustrates a fitted AAM face model on the stereo pair of FIG. 8, and represents an example of fitting the model on the stereo image pair, and illustrates identified positions of considered facial landmarks. An example of corresponding triangulated shapes is then illustrated in FIG. 12. The landmarks are used as control points for generating the 3D shape, based on their relative 2D displacement in the two images. The result is illustrated at FIG. 13 as corresponding triangulated meshes for the fitted model of FIG. 11.

The 3D shape model allows for 3D constraints to be imposed, making the face model more robust to pose variations; it also reduces the possibility of generating unnatural shape instances during the fitting process, subsequently reducing the risk of an erroneous convergence. Examples of efficient fitting algorithms for the new, so called 2D+3D, model are described at J. Xiao, S. Baker, I. Matthews, and T. Kanade, “Real-Time Combined 2D+3D Active Appearance Models,” in Proceedings of the IEEE Conference on Computer Vision and Pattern Recognition (CVPR'04), pp. 535-542, 2004; C. Hu, J. Xiao, I. Matthews, S. Baker, J. Cohn, and T. Kanade, “Fitting a single active appearance model simultaneously to multiple images,” in Proc. of the British Machine Vision Conference, September 2004; and S. C. Koterba, S. Baker, I. Matthews, C. Hu, J. Xiao, J. Cohn, and T. Kanade, “Multi-View AAM Fitting and Camera Calibration,” in Proc. International Conference on Computer Vision, October, 2005, pp. 511-518, which are each incorporated by reference.

Examples of full 3D face models, called 3D morphable models (3DMM), are described at V. Blanz and T. Vetter, “A morphable model for the synthesis of 3D faces,” in Proceedings of the 26th annual conference on Computer graphics and interactive techniques, pp. 187-194, 1999, incorporated by reference. Yet, these models have a high complexity and significant computational requirements, thus in certain embodiments the approaches based on the simpler AAM techniques are alternatively used, particularly for implementation in embedded systems. FIG. 13 illustrates a 3D shape generated from 2D stereo data with triangulation-based warping (see also FIG. 16).

### Portrait Enhancement with 3D Face Modeling

In certain embodiments, 3D faces may be used for gaming applications. In further embodiments, a 3D model may also be created within a camera from multiple acquired images. This model then allows enhancements of portrait images in particular by enabling refinements of the facial region based on distance from camera and the determination of the specific regions of a face (cheek, forehead, eye, hair, chin, nose, and so on.)

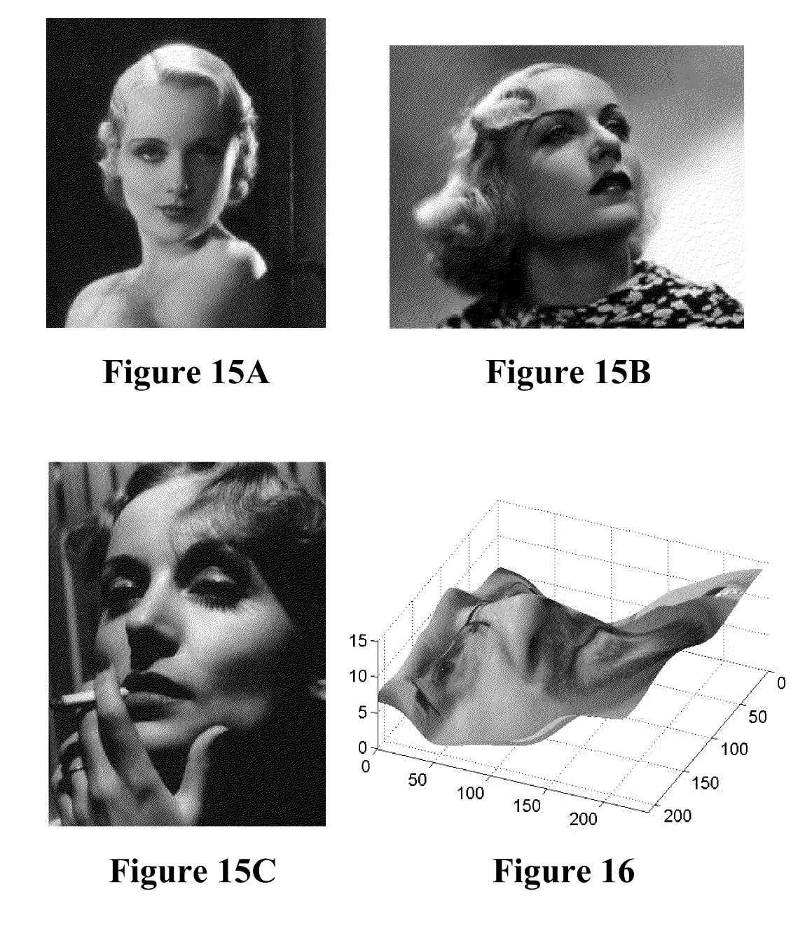

FIGS. 14A-14B and 15A, 15B and 15C are sample portrait images that illustrate certain effects that can result when a 3D face model is created within a camera. In some embodiments, a “generic” model may already be available in the camera and the stereo images may be used to refine this generic model to match an individual. Also, a stereo camera may be used in certain embodiments, while in others a stereo camera is not needed. In one alternative embodiment, a sequence of sweep panorama images are acquired, which involves moving “around” the subject, rather than “across” a panoramic scene. Unlike a panorama image, the camera would be pointed continuously at the subject, albeit from different perspectives (two such perspectives are illustrated at FIG. 8).

Scanning may be started, for example, from a left profile, followed by a sweep around the subject. A main (full res) image may be captured from a fully frontal perspective. The sweep may then continue to capture a right profile image. The various preview images may be used to construct a pseudo-3D depth map that may be applied to a post-process to enhance the main image.

In the context of depth of field (DOF), in a portrait enhancement mode, a sweep can be performed as just-described or alternatively similar to a sweep that may be performed when acquiring a panorama image, i.e., moving the camera along a linear or curvilinear path. While doing that, the camera can be continuously pointed at the same subject, rather than pointing it each time at a new scene overlapping and adjacent the previous one. At the end, after the camera acquires enough info, a full res image can be captured, or alternatively it can use one of the few images from the sweep, including initializing the sensor in continuous mode at sufficient resolution. Depth from parallax can be advantageously used. A good 3d map can be advantageously created for foreground/background separation. In the process, the camera may be configured to determine to fire the flash as well (i.e., if the light is too low, then flash could help for this).

Another way to obtain a 3D depth map is to use depth from defocus (DFD), which involves capturing at least two images of the same scene with different focal depths. For digital cameras that have a very uniform focal depth, this can be a more difficult approach than the others, but it may be used to generate a 3D depth map. In other embodiments, advantages can be realized using a combination of DFD and stereoscopic images.

FIG. 14A illustrates progressive blurring, while FIG. 14B illustrates selective blurring. In accordance with this embodiment, a technique may involve obtaining a stereoscopic image of a face using a dual-lens camera, or alternatively by moving the camera to capture facial images from more than one perspective, or alternatively employing a method such as depth from defocus (i.e., capturing at least two differently focused images of the same scene), or through combinations of these. A depth map may be created from these images. A 3D model of the face region may be generated from these images and the depth map. This 3D face model may be used to perform one or more of the following: improving foreground background separation of the modeled face; applying progressive blurring to the face region based on the distance of different portions of the face model from the camera as determined from either the depth map, or the 3D model or both; applying selective blurring to the face based on a combination of distance from the camera and the type of face region (e.g., hair, eyes, nose, mouth, cheek, chin, or regions and/or combinations thereof. The following are incorporated by reference as disclosing various alternative embodiments and applications of described embodiments: U.S. Pat. Nos. 7,606,417, 7,680,342, 7,692,696, 7,469,071, 7,515,740 and 7,565,030, and US published applications nos. 2010/0126831. 2009/0273685, 2009/0179998, 2009/0003661, 2009/0196466, 2009/0244296, 2009/0190803, 2009/0263022, 2009/0179999, 2008/0292193, 2008/0175481, 2007/0147820, and 2007/0269108, and U.S. Ser. No. 12/636,647.

FIG. 15A illustrates an image acquired of a frontal face pose, with simple directional lighting, e.g., from the left. FIG. 15B further illustrates directional lighting. The shadows are even apparent from eyelashes and from the nose demonstrating sophisticated post-acquisition effects that are achieved with 3D modeling. FIG. 15C also illustrates directional lighting. In this example, cheek regions are strongly shaded although it is to the foreground, demonstrating the selective application of the directional lighting effect to the cheek and eye regions, and eyelash shadows are again apparent. In accordance with these embodiments, a technique may involve obtaining a stereoscopic image of the face using a dual-lens camera, or alternatively by moving the camera to capture facial images from more than one perspective or alternatively employing a method such as depth from defocus (i.e. capturing at least two differently focused images of the same scene) or through combinations of these. A depth map may be created from these images. A 3D model may be generated of a face region (or another object or region) from these images and the depth map. The 3D model may include a first set of illuminations components corresponding to a frontally illuminated face and a second set of illumination components corresponding to a directionally illuminated face. The 3D face model may be used to perform one or more of the following: improving foreground background separation of the modeled face; applying progressive directional illumination to the face region based on the distance of different portions of the face model from the camera as determined from either the depth map, or the 3D model or both; applying selective directional illumination to the face based on a combination of distance from the camera and the type of face region (hair, eyes, nose, mouth, cheek, chin, and/or regions and/or combinations thereof).

In an alternative embodiment, a digital camera may be set into a “portrait acquisition” mode. In this mode the user aims the camera at a subject and captures an image. The user is then prompted to move (sweep) the camera slightly to the left or right, keeping the subject at the center of the image. The camera has either a motion sensor, or alternatively may use a frame-to-frame registration engine, such as those that may also be used in sweep panorama techniques, to determine the frame-to-frame displacement. Once a camera has moved approximately 6-7 cm from its original position, the camera acquires a second image of the subject thus simulating the effect of a stereo camera. The acquisition of this second image is automatic, but may be associated with a cue for the user, such as an audible “beep” which informs that the acquisition has been successful.

After aligning the two images a depth map is next constructed and a 3D face model is generated. In alternative embodiments, a larger distance may be used, or more than two images may be acquired, each at different displacement distances. It may also be useful to acquire a dual image (e.g. flash+no-flash) at each acquisition point to further refine the face model. This approach can be particularly advantageous in certain embodiments for indoor images, or images acquired in low lighting levels or where backlighting is prevalent.

The distance to the subject may be advantageously known or determined, e.g., from the camera focusing light, from the detected size of the face region or from information derived within the camera autofocus engine or using methods of depth from defocus, or combinations thereof. Additional methods such as an analysis of the facial shadows or of directional illumination on the face region (see, e.g., US published applications nos. 2008/0013798, 2008/0205712, and 2009/0003661, which are each incorporated by reference and relate to orthogonal lighting models) may additionally be used to refine this information and create an advantageously accurate depth map and subsequently, a 3D face model.

### Model Application

### 3D Gaming Avatars

A triangulation-based, piecewise affine method may be used for generating and fitting statistical face models. Such may have advantageously efficient computational requirements. The Delauney triangulation technique may be used in certain embodiments, particularly for partitioning a convex hull of control points. The points inside triangles may be mapped via an affine transformation which uniquely assigns the corners of a triangle to their new positions.

A different warping method, that yields a denser 3D representation, may be based on thin plate splines (TPS) (see, e.g., F. Bookstein, “Principal warps: Thin-plate splines and the decomposition of deformations,” Pattern Analysis and Machine Intelligence, IEEE Transactions on, vol. 11, no. 6, pp. 567-585, June 1989, incorporated by reference). Further examples of the use of TPS for improving the convergence accuracy of color AAMs are provided at M. C. Ionita and P. Corcoran, “Benefits of Using Decorrelated Color Information for Face Segmentation/Tracking,” Advances in Optical Technologies, vol. 2008, Article ID 583687, 8 pages, 2008. doi:10.1155/2008/583687, incorporated by reference. TPS-based warping may be used for estimating 3D face profiles.

In the context of generating realistic 3D avatars, the choice of TPS-based warping technique offers an advantageous solution. This technique is more complex that the piecewise linear warping employed for example above; yet simplifies versions are possible with reduced computational complexity. TPS-based warping represents a nonrigid registration method, built upon an analogy with a theory in mechanics. Namely, the analogy is made with minimizing the bending energy of a thin metal plate on which pressure is exerted using some point constraints. The bending energy is then given by a quadratic form; the spline is represented as a linear combination (superposition) of eigenvectors of the bending energy matrix:

$$f ( x , y ) = {a}_{1} + {a}_{x} x + {a}_{y} y + {\sum }_{i = 1}^{p} {w}_{i} U ( ‖ ( {x}_{i} , {y}_{i} ) - ( x , y ) ‖ ) . \qquad ( 7 )$$

where U(r)=r² log(r); (xᵢ, yᵢ) are the initial control points. a=(a₁ aₓ a_{y}) defines the affine part, while w defines the nonlinear part of the deformation. The total bending energy is expressed as

$${I}_{f} = \int {\int }_{{R}^{2}}^{ } ( {( \frac{{\partial }^{2} f}{\partial {x}^{2}} )}^{2} + 2 {( \frac{{\partial }^{2} f}{\partial x \partial y} )}^{2} + {( \frac{{\partial }^{2} f}{{\partial }^{2} y} )}^{2} ) d x d y . \qquad ( 8 )$$

The surface is deformed such that to have minimum bending energy. The conditions that need to be met so that (7) is valid, i.e., so that f (x, y) has second-order derivatives, are given by

$$\begin{matrix}{\sum }_{i = 1}^{v} {w}_{i} = 0 \\ and & ( 9 ) \\ {\sum }_{i = 1}^{p} {w}_{i} {x}_{i} = 0 ; {\sum }_{i = 1}^{p} {w}_{i} {y}_{i} = 0. & ( 10 )\end{matrix}$$

Adding to this the interpolation conditions f(xᵢ, yᵢ)=vᵢ, (7) can now be written as the linear system in (10):

$$[ \begin{matrix}K & P \\ {P}^{T} & O\end{matrix} ] [ \begin{matrix}w \\ a\end{matrix} ] = [ \begin{matrix}v \\ o\end{matrix} ] , \qquad ( 11 )$$

where Kᵢⱼ=U(∥(xᵢ, yᵢ)−(xⱼ, yⱼ)∥), O is a 3×3 matrix of zeros, o is a 3×1 vector of zeros, Pᵢⱼ=(1, xᵢ, yᵢ); w and v are the column vectors formed by wᵢ and vᵢ, respectively, while a=[a₁ aₓ a_{y}]T.

FIG. 16 illustrates an estimated 3D profile from 2D stereo data using Thin Plate Spline-based warping. The main drawback of using the thin plate splines used to be considered their high computational load. The solution involves the inversion of a p x p matrix (the bending energy matrix) which has a computational complexity of O(N³), where p is the number of points in the dataset (i.e., the number of pixels in the image); and furthermore, the evaluation process is O(N²). However, progress has been made and will continue to be made that serves to speed this process up. For example, an approximation approach was proved in G. Donato and S. Belongie, “Approximate thin plate spline mappings,” in ECCV (3), 2002, pp. 21-31, incorporated by reference, and such has been observed to be very efficient in dealing with the first problem, reducing greatly the computational burden. As far as the evaluation process is concerned, the multilevel fast multipole method (MLFMM) framework was described in R. K. Beatson and W. A. Light, “Fast evaluation of radial basis functions: methods for two-dimensional polyharmonic splines,” IMA Journal of Numerical Analysis, vol. 17, no. 3, pp. 343-372,1997, incorporated by reference, for the evaluation of two-dimensional polyharmonic splines. Meanwhile, in A. Zandifar, S.-N. Lim, R. Duraiswami, N. A. Gumerov, and L. S. Davis, “Multi-level fast multipole method for thin plate spline evaluation.” In ICIP, 2004, pp. 1683-1686, incorporated by reference, this work was extended for the specific case of TPS, showing that a reduction of the computational complexity from O(N²) to O(N logN) is indeed possible. Thus the computational difficulties involving the use of TPS have been greatly reduced. Based on this warping technique, 3D facial profiles may be generated as illustrated at FIG. 16.

Embodiments have been described to build improved AAM facial models which condense significant information about facial regions within a relatively small data model. Methods have been described which allow models to be constructed with orthogonal texture and shape subspaces. These allow compensation for directional lighting effects and improved model registration using color information.

These improved models may then be applied to stereo image pairs to deduce 3D facial depth data. This enables the extension of the AAM to provide a 3D face model. Two approaches have been described, one based on 2D+3D AAM and a second approach based on thin plate spline warpings. Those based on thin plate splines are shown to produce a particularly advantageous 3D rendering of the face data. These extended AAM based techniques may be combined with stereoscopic image data offering improved user interface methods and the generation of dynamic real-time avatars for computer gaming applications.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention.

In addition, in methods that may be performed according to preferred embodiments herein and that may have been described above, the operations have been described in selected typographical sequences. However, the sequences have been selected and so ordered for typographical convenience and are not intended to imply any particular order for performing the operations, except for those where a particular order may be expressly set forth or where those of ordinary skill in the art may deem a particular order to be necessary.

In addition, all references cited above and below herein, as well as the background, invention summary, abstract and brief description of the drawings, are all incorporated by reference into the detailed description of the preferred embodiments as disclosing alternative embodiments.

The following are incorporated by reference: U.S. Pat. Nos. 7,715,597, 7,702,136, 7,692,696, 7,684,630, 7,680,342, 7,676,108, 7,634,109, 7,630,527, 7,620,218, 7,606,417, 7,587,068, 7,403,643, 7,352,394, 6,407,777, 7,269,292, 7,308,156, 7,315,631, 7,336,821, 7,295,233, 6,571,003, 7,212,657, 7,039,222, 7,082,211, 7,184,578, 7,187,788, 6,639,685, 6,628,842, 6,256,058, 5,579,063, 6,480,300, 5,781,650, 7,362,368, 7,551,755, 7,515,740, 7,469,071, 5,978,519, 7,630,580, 7,567,251, 6,940,538, 6,879,323, 6,456,287, 6,552,744, 6,128,108, 6,349,153, 6,385,349, 6,246,413, 6,604,399 and 6,456,323; and
U.S. published application nos. 2002/0081003, 2003/0198384, 2003/0223622, 2004/0080631, 2004/0170337, 2005/0041121, 2005/0068452, 2006/0268130, 2006/0182437, 2006/0077261, 2006/0098890, 2006/0120599, 2006/0140455, 2006/0153470, 2006/0204110, 2006/0228037, 2006/0228038, 2006/0228040, 2006/0276698, 2006/0285754, 2006/0188144, 2007/0071347, 2007/0110305, 2007/0147820, 2007/0189748, 2007/0201724, 2007/0269108, 2007/0296833, 2008/0013798, 2008/0031498, 2008/0037840, 2008/0106615, 2008/0112599, 2008/0175481, 2008/0205712, 2008/0219517, 2008/0219518, 2008/0219581, 2008/0220750, 2008/0232711, 2008/0240555, 2008/0292193, 2008/0317379, 2009/0022422, 2009/0021576, 2009/0080713, 2009/0080797, 2009/0179998, 2009/0179999, 2009/0189997, 2009/0189998, 2009/0189998, 2009/0190803, 2009/0196466, 2009/0263022, 2009/0263022, 2009/0273685, 2009/0303342, 2009/0303342, 2009/0303343, 2010/0039502, 2009/0052748, 2009/0144173, 2008/0031327, 2007/0183651, 2006/0067573, 2005/0063582, PCT/US2006/021393; and
U.S. patent applications Nos. 60/829,127, 60/914,962, 61/019,370, 61/023,855, 61/221,467, 61/221,425, 61/221,417, 61/106,910, 61/182,625, 61/221,455, 61/091,700, and 61/120,289; and
Kampmann, M. [Markus], Ostermann, J. [Jörn], Automatic adaptation of a face model in a layered coder with an object-based analysis-synthesis layer and a knowledge-based layer, Signal Processing: Image Communication, (9), No. 3, March 1997, pp. 201-220.
Markus, Ostermann: Estimation of the Chin and Cheek Contours for Precise Face Model Adaptation, IEEE International Conference on Image Processing, '97 (III: 300-303).
Lee, K. S. [Kam-Sum], Wong, K. H. [Kin-Hong], Or, S. H. [Siu-Hang], Fung, Y. F. [Yiu-Fai], 3D Face Modeling from Perspective-Views and Contour-Based Generic-Model, Real Time Imaging, (7), No. 2, April 2001, pp. 173-182.
Grammalidis, N., Sarris, N., Varzokas, C., Strintzis, M. G., Generation of 3-d Head Models from Multiple Images Using Ellipsoid Approximation for the Rear Part, IEEE International Conference on Image Processing, '00 (Vol I: 284-287).
Sarris, N. [Nikos], Grammalidis, N. [Nikos], Strintzis, M. G. [Michael G.], Building Three Dimensional Head Models, GM(63), No. 5, September 2001, pp. 333-368.
Grammalidis, N., Sarris, N., Varzokas, C., Strintzis, M. G., Generation of 3-d Head Models from Multiple Images Using Ellipsoid Approximation for the Rear Part, ICIP00(Vol I: 284-287).
M. Kampmann, L. Zhang, Liang Zhang, Estimation of Eye, Eyebrow and Nose Features in Videophone Sequences, Proc. International Workshop on Very Low Bitrate Video Coding, 1998.
Yin, L. and Basu, A., Nose shape estimation and tracking for model-based coding, IEEE International Conference on Acoustics, Speech, and Signal Processing, 2001 Vol 3 (ISBN: 0-7803-7041-4).
Markus Kampmann, Segmentation of a Head into Face, Ears, Neck and Hair for Knowledge-Based Analysis-Synthesis Coding of Videophone Sequences, Int. Conf. on Image Processing, 1998.

What is claimed is:

1. An image processing method using a 3D face model, comprising:
generating a stereoscopic image of a face, including using a dual-lens camera, or using a method including moving a camera relative to the face to capture facial images from more than one perspective, or applying a depth from defocus process including capturing at least two differently focused images of an approximately same scene, or combinations thereof;
creating a depth map based on the stereoscopic image;
generating a 3D face model of the face region from the stereoscopic image and the depth map; and
applying the 3D face model to process an image.

2. The method of claim 1, further comprising applying a foreground/background separation operation, wherein the modeled face comprises a foreground region.

3. The method of claim 1, further comprising applying progressive blurring to the face region based on distances of different portions of the face model from the camera as determined from either the depth map, or the 3D model, or both.

4. The method of claim 3, further comprising applying selective blurring to the face based on a combination of distance from the camera and the type of face region.

5. The method of claim 4, wherein the type of face region comprises a hair region, one or both eyes, a nose or nose region, a mouth or mouth region, a cheek portion, a chin or chin region, or combinations thereof.

6. The method of claim 3, further comprising applying selective blurring to the face based on a combination of distance from the camera and the type of face region.

7. The method of claim 1, wherein said 3D face model comprises a first set of one or more illumination components corresponding to a frontally illuminated face and a second set of one or more illumination components corresponding to a directionally illuminated face.

8. The method of claim 7, further comprising applying a foreground/background separation operation, wherein the modeled face comprises a foreground region.

9. The method of claim 7, further comprising applying progressive directional illumination to the face based on distances of different portions of the face from the camera as determined from the depth map or the 3D model, or both.

10. The method of claim 7, further comprising applying selective directional illumination to the face based on a combination of distance from the camera and type of face region.

11. The method of claim 10, wherein the type of face region comprises a hair region, one or both eyes, a nose or nose region, a mouth or mouth region, a cheek portion, a chin or chin region, or combinations thereof.

12. A method of determining a characteristic of a face within a scene captured in a digital image, comprising:
acquiring digital images from at least two perspectives including a face within a scene, and generating a stereoscopic image based thereon;
generating and applying a 3D face model based on the stereoscopic image, the 3D face model comprising a class of objects including a set of model components;
obtaining a fit of said model to said face including adjusting one or more individual values of one or more of the model components of said 3D face model;
based on the obtained fit of the model to said face in the scene, determining at least one characteristic of the face; and
electronically storing, transmitting, applying face recognition to, editing, or displaying a modified version of at least one of the digital images or a 3D image based on the acquired digital images including the determined characteristic or a modified value thereof, or combinations thereof.

13. The method of claim 12, wherein the model components comprise eigenvectors, and the individual values comprise eigenvalues of the eigenvectors.

14. The method of claim 12, wherein the at least one determined characteristic comprises a feature that is independent of directional lighting.

15. The method of claim 12, further comprising determining an exposure value for the face, including obtaining a fit to the face to a second 3D model that comprises a class of objects including a set of model components that exhibit a dependency on exposure value variations.

16. The method of claim 15, further comprising reducing an effect of a background region or density contrast caused by shadow, or both.

17. The method of claim 12, further comprising controlling a flash to accurately reflect a lighting condition, including obtaining a flash control condition by referring to a reference table and controlling a flash light emission according to the flash control condition.

18. The method of claim 17, further comprising reducing an effect of contrasting density caused by shadow or black compression or white compression or combinations thereof.

19. The method of claim 12, wherein the set of model components comprises a first subset of model components that exhibit a dependency on directional lighting variations and a second subset of model components which are independent of directional lighting variations.

20. The method of claim 19, further comprising applying a foreground/background separation operation, wherein the modeled face comprises a foreground region.

21. The method of claim 19, further comprising applying progressive directional illumination to the face based on distances of different portions of the face from the camera as determined from the depth map or the 3D model, or both.

22. The method of claim 19, further comprising applying selective directional illumination to the face based on a combination of distance from the camera and type of face region.

23. The method of claim 22, wherein the type of face region comprises a hair region, one or both eyes, a nose or nose region, a mouth or mouth region, a cheek portion, a chin or chin region, or combinations thereof.

24. A digital image acquisition device including an optoelectonic system for acquiring a digital image, and a digital memory having stored therein processor-readable code for programming the processor to perform a method as recited at any of claims 1-23.

25. One or more computer readable storage media having code embedded therein for programming a processor to perform a method as recited at any of claims 1-23.
